(19) United States
(12) Patent Application Publication
(10) Pub. No.: US 2008/0097876 A1
(43) Pub. Date: Apr. 24, 2008

(54) Programmable expiration date verification system

(76) Inventors: George William White, Leanyer Darwin (AU); Erik Skov, Gunn (AU)

Correspondence Address: Galasso & Associates, LP, P.O. Box 26503, Austin, TX, 78755-0503, US

(21) Appl. No.: 11/501,447

(22) Filed: Oct. 19, 2006

(51) Int. Cl. G06Q 20/00; G06G 1/14; G06Q 10/00

(52) U.S. Cl. 705/28; 705/22; 705/23

(57) ABSTRACT

A programmable expiration date verification system is disclosed. According to one aspect, a programmable expiration date verification system including a programmable expiration date module is provided. The programmable expiration date module includes a memory device operable to store an expiration date and a communication port operable to receive a communication including the expiration date. The programmable expiration date module further includes a processor operably coupled to the memory and the processor is operable to determine the expiration date. A visual indicator operable to be altered by the processor in response to determining the expiration date.

### FIELD OF THE DISCLOSURE

The present invention generally relates to verification systems, and more particularly, to a programmable expiration date verification system.

### BACKGROUND

Various techniques for ensuring expiration dates for time sensitive products have been employed. For example, some goods have a limited shelf life and manufacturers often provide expiration dates that are placed at various locations on packaging. However, some of the dates provided are difficult to read or discern. For example, some manufacturers have printed expiration dates on packages indicating when a good contained within a package will expire. However, some printed dates are difficult to read due to the size of the font or may have been printed using ink that does not dry quickly and may have become smeared during the delivery, stocking, or purchase process.

In some instances, a date may be stamped into a package to reduce the possibility of becoming illegible. However, some conventional stamping is difficult to read and moreover may not be usable with some types of packaging. For example, plastic cartons for holding liquids such as juice, milk, water, etc. may not benefit from stamping or imprinting an expiration date into a plastic material. Thus, manufacturers frequently use inks that may be subject to variable storage temperatures and handling. For example, dairy products such as milk stored within plastic or paper containers are often stamped with an expiration date using ink that may not dry or becomes illegible due to storing products at cool temperatures. Such inconsistent display of dates lead to undesired waste and increased expenses for a grocer resulting in cost increases that may be passed to consumers. As such, what is needed is a simplified inexpensive system for determining expiration dates for time sensitive goods and materials while reducing waste and man hours attributed questionable expiration dates of goods or products.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram illustrating a programmable expiration date verification system according to one aspect of the present invention;

FIG. 2 illustrates a front perspective view of a programmable expiration date verification system according to one aspect of the invention;

FIG. 3 illustrates a functional block diagram of a programmable expiration date verification system according to one aspect of the invention; and

FIG. 4 illustrates a flow diagram of a method of providing an expiration date using a programmable expiration date verification system according to one aspect of the invention.

### DETAILED DESCRIPTION

A programmable expiration date verification system is disclosed. According to one aspect, a programmable expiration date verification system including a programmable expiration date module is provided. The programmable expiration date module includes a memory device operable to store an expiration date and a communication port operable to receive a communication including the expiration date. The programmable expiration date module further includes a processor operably coupled to the memory and the processor is operable to determine the expiration date. A visual indicator operable to be altered by the processor in response to determining the expiration date. The system further includes a control module includes an input keypad operable to receive an entry of the expiration date and a display operable to display the entered expiration date. The control module further includes a communication port operable to communicate the expiration date to the programmable expiration date module.

According to another aspect of the invention, a control module operable to be used in association with a programmable verification system operable to communicate a digital representation of an expiration date to a programmable expiration date module. The control module includes an input keypad operable to receive an entry of the expiration date and a display operable to display the entered expiration date. The control module further includes a communication port operable to communicate the expiration date to the programmable expiration date module.

According to a further aspect of the invention, a programmable expiration date module operably associated with a verification system operable to provide an expiration date for an article is provided. The system includes a control module operable to communicate the expiration date for the article. The control module includes a memory device operable to store the expiration date and a communication port operable to receive the communication including the expiration date. The system further includes an indicator operable to be altered in response to determining the expiration date.

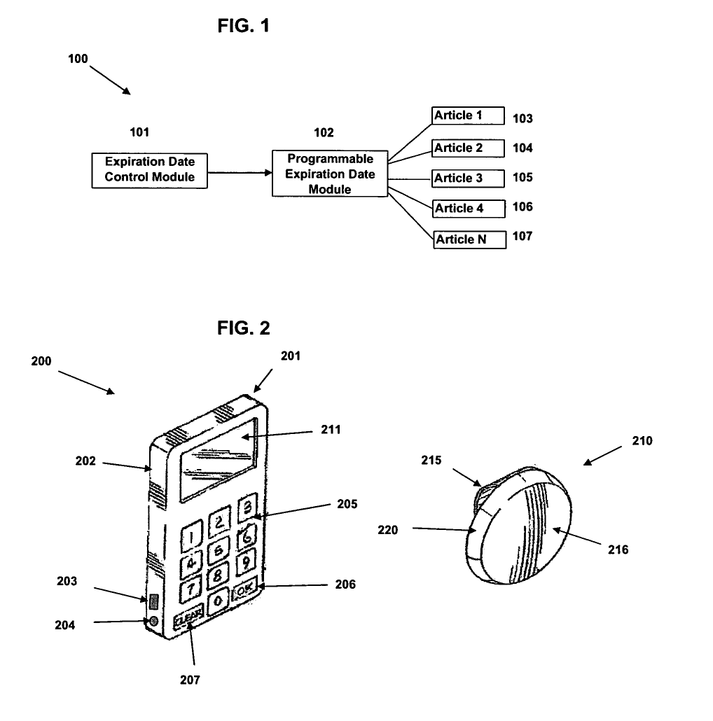

FIG. 1 illustrates a block diagram illustrating a programmable expiration date verification system according to one aspect of the present invention. A programmable expiration date verification system, illustrated generally as expiration date system 100, includes an expiration date control module 101 operable to communicate an expiration date to programmable expiration date module 102. Programmable expiration date module 102 is a digitally programmable module operable to be used with an article such as first article 103, second article 104, third article 105, fourth article 106, or Nth article 107 and includes an internal counter or clock operable to compare the expiration date provided to a current date and provide a visual indication based on the comparison. For example, programmable expiration date module 102 may include a lamp, light,-illuminator, light emitting diode (LED) or any other type of illumination device operable to be activated upon the expiration date being reached. In this manner, a user may visually check to see if an expiration date has been reached for a product obviating the need for a user to have to read an expiration date that may be printed on an article. In one embodiment, more than one programmable expiration date module 102 may be provided for plural articles with each programmable expiration date module including a separate expiration date for each article as needed.

During use, a user enters an expiration date for a specific article, such as first article 103, using a keypad associated with expiration date control module 101. Expiration date control module 101 communicates the expiration date to programmable expiration date module 102 using a wireless or wireline communication port or module (not expressly shown). For example, expiration date control module 101 may be coupled to programmable expiration date module 102 via an Input/Output (I/O) port and cable coupled between expiration date control module 101 and programmable expiration date module 102. In other embodiments, various types of communication and communication mediums may be employed. For example, a universal serial bus (USB) enabled communication medium, a TCP/IP enabled communication medium, a proprietary communication medium, etc. may be employed. In one form, a wireless communication medium such as an infra-red communication medium, a short range RF communication medium such as an 802.11-based communication medium, or long range RF communication medium using a CDP, TDMA, or paging networks, may be employed to communicate an expiration date. Other mediums, modules, or protocols may also be used.

Upon expiration date control module 101 communicating an expiration date, programmable expiration date module 102 stores a digital representation of the expiration date for a specific article within memory of programmable expiration date module 102 and programmable expiration date module 102 may then be provided in association with an article. For example, programmable expiration date module 102 may be coupled to an article using a clip, an adhesive, a hook and loop material, or using various other coupling mechanisms. Programmable expiration date module 102 then determines a current date a periodically verifies if an expiration date has been achieved. If an expiration date is achieved, programmable expiration date module 102 illuminate a visual indicator indicating that first article 103 has expired. In this manner, a user may quickly determine if an expiration date has been achieved thereby reducing the amount of time to determine expiration dates for products, goods, etc.

FIG. 2 illustrates a front perspective view of a programmable expiration date verification system according to one aspect of the invention. A programmable expiration date verification system, illustrated generally at 200, includes a control module 201 having a housing 202 formed of a durable plastic material such as a high-impact durable plastic material and is formed generally as a rectangular-shaped housing. In one embodiment, housing 202 is formed to include a width of approximately three (3) to four (4) inches, a length of approximately three (3) to five (5) inches, and a width or thickness of approximately one-quarter (¼) inch. Housing 202 may be formed using one or more plastic manufacturing processes. For example, a plastic manufacturing process of injection molding or blow molding may used to form housing 202. Injection molding is a process that is used in mass production of materials and include melted plastic being forcefully injected into a relatively cool mold. As the plastic material hardens, it takes on the shape of the mold cavity. One skilled in the art can appreciate that other methods of forming housing 202 may also be used either alone or in combination with the methods described above. Additionally, other shapes and dimensions may be selected for forming housing 202 as desired.

Control module 201 also includes a power switch 203 operably coupled to a power source (not expressly shown) such as one or more batteries or an AC power source or adaptor (not expressly shown) using power port 204. AC power adaptors allow an AC power source to be converted into a direct current power for powering control module 201 and/or recharging a power source of control module 201. An AC adapter may be provided internal or external to housing 202. Control module 201 further includes a keypad 205 having numeric keys labeled with numbers and an enter or ok key 206 operable to enter, edit or store a date displayed on display 211 and a clear key 207 operable to erase a date or series of dates displayed within display 211. Display 211 may be configured to display up to ten (10) characters using a grayscale liquid crystal display (LCD) elements. However, other types or combinations of displays or display elements (i.e. color displays, light emitting diodes (LEDs), thin film transistors (TFTs), etc.) may also be used.

In one embodiment, a mobile or cellular telephone may be well suited for programming a programmable expiration date module 210. For example, a WiFi or Bluetooth enabled mobile phone or other mobile phone operable to communicate using a low power RF communication medium, may be programmed to include software for allowing a user to enter an expiration date. The expiration date may then be communicated using a low power RF communication medium to a programmable exportation date module 210.

During operation, when power switch 203 is placed in an ‘ON’ position, control module 201 is initialized and display 211 is illuminated indicating that control module 201 is powered on. A user may then enter an expiration date. For example, a user may enter a date using the format “MM-DD-YYYY”, “DD-MM-YYYY”, or any other type of format that may be used to program an expiration date. Upon entering a date using keypad 205, a user may select the ok key 206 and data presented within display 211 is stored within memory of control module 201. If a user desires to erase contents displayed within display 211, a user may select clear switch 207 to clear data displayed within display 211. Control module 201 may be configured to erase one character or all characters displayed within display 211 when clear key 207 is selected.

System 200 further includes a programmable expiration date module 210 including a housing 220 and a visual indicator 216 operable to be illuminated upon an expiration date being achieved. Housing 220 is provided a circular shaped housing and in one form is approximately one (1) inch in diameter. In other embodiments, various other shapes and sizes may be employed as desired. In one form, programmable expiration date module 210 may be provided with a coupling mechanism 215 such as an adhesive strip, clip, or other coupling mechanism coupled to a portion of housing 220 to allow for mounting of programmable expiration date module 210 on various goods, articles, etc. A hook and loop material may also be used to allow for increased portability and mounting of programmable expiration date module 210. In one embodiment, a user may desire to mount programmable expiration date module 210 to a box containing perishable goods, a carton or jug containing dairy products, or any other type of time sensitive article or good that may benefit from monitoring an expiration date of stored contents. For example, some industrial manufacturing processes require monitoring of goods, materials, chemicals, etc. as a part of a manufacturing process. As such, programmable expiration date module 210 may be fixed to the goods, materials, chemicals, etc. such that an operator or laborer may select an appropriate raw material to use during a manufacturing process. In this manner, wasted materials may be reduced thereby reducing manufacturing costs of goods or materials.

Programmable expiration date module 210 further includes a battery compartment for housing a low-voltage battery (not expressly shown) for powering programmable expiration date module 210. In one embodiment, a low-voltage battery may include a low-voltage direct current or DC batteries ranging between 0.5 volts and nine (9) volts and may be configured as a small form battery such as a ‘button’ sized batteries utilized by some conventional electronic watches. Programmable expiration date module 210 may also include a charge port (not expressly shown) for recharging rechargeable batteries if rechargeable batteries are used and may be connected to an external power source operable to provide power sufficient to recharge rechargeable batteries if used.

During use, a user enters an expiration date for a specific article using keypad 205 of expiration date control module 201. Expiration date control module 201 communicates the expiration date to programmable expiration date module 210 using a wireless or wireline communication port or module (not expressly shown) and programmable expiration date module 210 stores a digital representation of the expiration date for a specific article within memory. For example, if a wireline connection is used, a digital representation of the expiration date is communicated from a communication port of control module 201 to a communication port of programmable expiration date module 210. Programmable expiration date module 210 may then be provided in association with an article. For example, programmable expiration date module 210 may be coupled to an article using coupling mechanism 215. Upon associating with an article, programmable expiration date module 102 may then periodically determining if an expiration date has been achieved and, upon encountering an expiration date, programmable expiration date module 210 illuminates visual indicator 216 indicating that an expiration date for an associated article has been achieved.

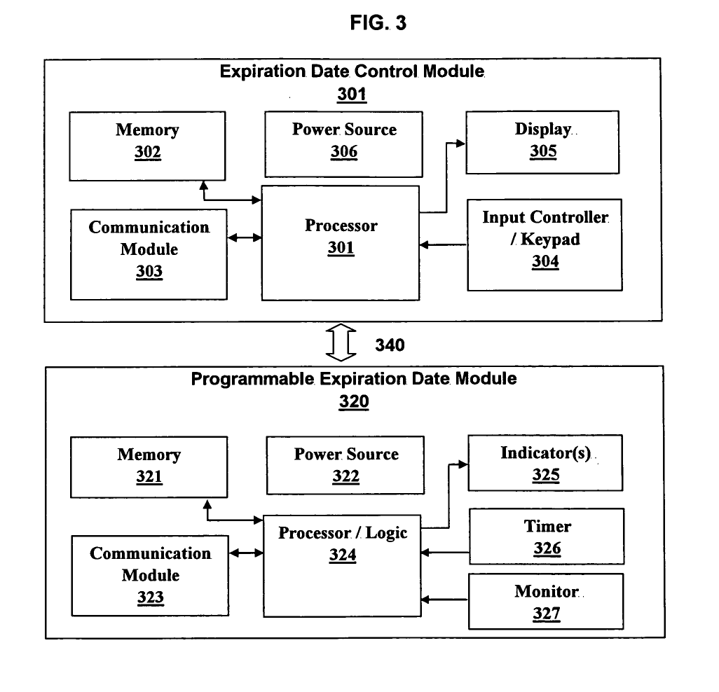

FIG. 3 illustrates a functional block diagram of a programmable expiration date verification system according to one aspect of the invention. A programmable expiration date verification system, illustrated generally at 300, includes a control module 301 and a programmable expiration date module 320 operable to be programmed by control module 301 using communication medium 340. Control module 301 includes a processor 301 operable as a controller for controlling and processing data or inputs to control module 301. Processor 301 may include a microprocessor or microcontroller for controlling and processing data. For example, a single-chip microcontroller with on-board program read only memory (ROM) and input/output (I/O) can be programmed for various control functions and may be provided as a single chip or electronic circuit that includes all or most of the parts needed for a controller including a central processing unit (CPU), Random Access Memory (RAM), Erasable Programmable Read Only Memory (EPROM/PROM/ROM), an I/O (input/output) controller, serial and parallel timers, and an interrupt controller. In one embodiment, a typical microcontroller including low bit manipulation instructions, easy and direct access to I/O (input/output), and quick and efficient interrupt processing may be employed by control module 301.

Expiration date control module 301 includes a display 305 operable to display a string of alphanumeric characters using one or more types of display types such as liquid crystal diodes (LCDs), light emitting diodes (LEDs), thick film transistor (TFT) displays, and the like. Memory 302 may include RAM, ROM, EPROM, EEPROM, Flash Memory, or other types of memory and/or programmable memory as needed. Expiration date control module 301 further includes an input controller and keypad 304 for inputting data into expiration date control module 301 and includes numeric keys having a single key for numbers ranging between zero (0) and nine (9).

Expiration date control module 301 further includes a communication module 303 operable to communicate with programmable expiration date module 320 via communication medium 340. via an Input/Output (I/O) port and cable coupled between expiration date control module 101 and programmable expiration date module 102. Various types of communication and communication mediums may be employed. For example, a universal serial bus (USB) enabled communication medium, a TCP/IP enabled communication medium, a proprietary communication medium, etc. may be employed. In one form, a wireless communication medium such as an infra-red communication medium, a short range RF communication medium such as an 802.11-based communication medium, or long range RF communication medium using a CDPD, TDMA, or paging networks, may be employed to communicate an expiration date. Other mediums, modules, or protocols may also be used. As such, communication module 303 may take on various forms of communication mediums as needed.

Display 305 includes logic for enabling display of alphanumeric characters. Power supply 306 may include a low-voltage power supply to provide power to each component of expiration date control module 301 as needed and may include one or more power buses provided through various voltage regulators, converters, etc. as needed (not expressly shown). In one embodiment a single voltage level (i.e. 1.5 Volts) may be used by all components illustrated however in other embodiments, various levels such as 0.5 Volts, 1.5 Volts and 3.3 Volts may be used depending on the type of component(s) used by expiration date control module 301.

During operation, processor 301 initializes expiration date control module 301 and ensures that each component is functioning properly. For example, processor 301 may include an initialization sequence or routine that is used to initialize each electronic component of expiration date control module 301 to determine an operating or functional status of each component. Such initialization routine may include receiving a predetermined voltage level at an input port (not expressly shown) of processor 301 in response to initializing each component. Other types of initialization routines may also be employed.

Expiration date control module 301 may also include a communication bus (not expressly shown) for communicating data or information between components of expiration date control module 301. For example, processor 301 may request information stored at a specific location within memory 302 and as such a request for information may be processed by a memory controller of memory 302 and communicated to processor 301 via a communication bus. For example, contents of the memory location may be placed on a communication bus for use by other components of expiration date control module 301 as needed. For example, in one embodiment, display 305 may read data provided on a communication bus via input controller/keypad 304 and entered by a user and display to a user for editing, entering etc.

Keypad 304 includes a single key for each number representing a single digit (0 to 9). Keys for other character types may also be considered in various embodiments of the invention including. For example, keypad 304 may include a set of keys similar to a telephone or cellular phone keypad. Expiration date control module 301 may include logic to enable a user to enter text through use of a standard telephone keypad where each number key includes an associated alpha character or group of alpha characters. For example, the “2” key of telephone keypad includes alpha characters “ABC” provided in association with the “2” key. A user may then access each letter by sequentially selecting the “2” key based on the position of the character. For example, a user may select the “2” key twice and the letter “B” may be populated within display 305. Expiration date control module 301 may also include other logic to auto-populate characters and words (T9 logic) based on a users interaction with keypad 304. Keypad 304 further includes a clear key allowing a user to edit numbers or characters entered and displayed by display 305. A user may select a clear key and the last character displayed in the string of characters would be erased.

Programmable expiration date verification system 300 further includes a programmable expiration date module 320 including a processor/logic 324 coupled to a memory 321, indicator(s) 325, a timer 326 such as a system clock or crystal, a monitor 327 and a communication module 323. Programmable expiration date module 320 may include various types of processors, controllers, digital logic, etc. operable to determine when an expiration date has been achieved and in one embodiment may include a microcontroller including low bit manipulation instructions, easy and direct access to I/O (input/output), and quick and efficient interrupt processing. Memory 321 may be internal or external to processor/logic 324 and may include RAM, ROM, EPROM, EEPROM, Flash Memory, or other types of memory and/or programmable memory as needed for storing logic, code, or various other types of programs or software. Additionally, memory 321 is operable to store one ore more expiration dates communicated by control module 301. For example, memory 321 may store an expiration date at specific location within memory 321 and processor 324 may access a specific address within memory 321 to obtain an expiration date. As such, memory 321 may be configured as a reprogrammable memory such as RAM, EPROM, EEPROM, Flash, etc. operable to store an updated expiration date.

Power source 322 includes a low-voltage power supply to provide power to each component of programmable expiration date module 340 as needed and may include one or more power buses provided through various voltage regulators, converters, etc. as needed (not expressly shown). In one embodiment a single voltage level (i.e. 1.5 Volts) may be used by all components illustrated however in other embodiments, various levels such as 0.5 Volts, 1.5 Volts and 3.3 Volts may be used depending on the type of component(s) used by programmable expiration date module 320.

Programmable expiration date module 320 further includes a communication and control module 323 operable to communicate information between expiration date control module 301 and communication bus 340. Various types of communication and communication mediums may be employed by communication module 323. For example, a universal serial bus (USB) enabled communication medium, a TCP/IP enabled communication medium, a proprietary communication medium, etc. may be employed. In one form, a wireless communication medium such as an infra-red communication medium, a short range RF communication medium such as an 802.11-based communication medium, or long range RF communication medium using a CDPD, TDMA, or paging networks, may be employed to communicate an expiration date. Other mediums, modules, or protocols may also be used. As such, communication module 323 may take on various forms of communication mediums as needed.

In one form, several programmable expiration date modules 320 may be programmed at the same time. For example, several wireless enabled programmable expiration date modules 320 may be programmed in a ‘batch mode’ to include the same expiration date. In this manner, when a shipment of a goods or materials having the same expiration date are received, a user need only communicate a single expiration date to several expiration date modules 320 allowing a user to efficiently program several expiration date modules.

In one embodiment, programmable expiration date module 320 may not be reprogrammed until after an expiration date expires. For example, several goods or materials having different expiration dates may be stored together and as such maintains s respective expiration date using a programmable expiration date module 320. In this manner, a user may program new expiration dates for newly stocked goods and materials without effecting expiration dates for other goods or materials.

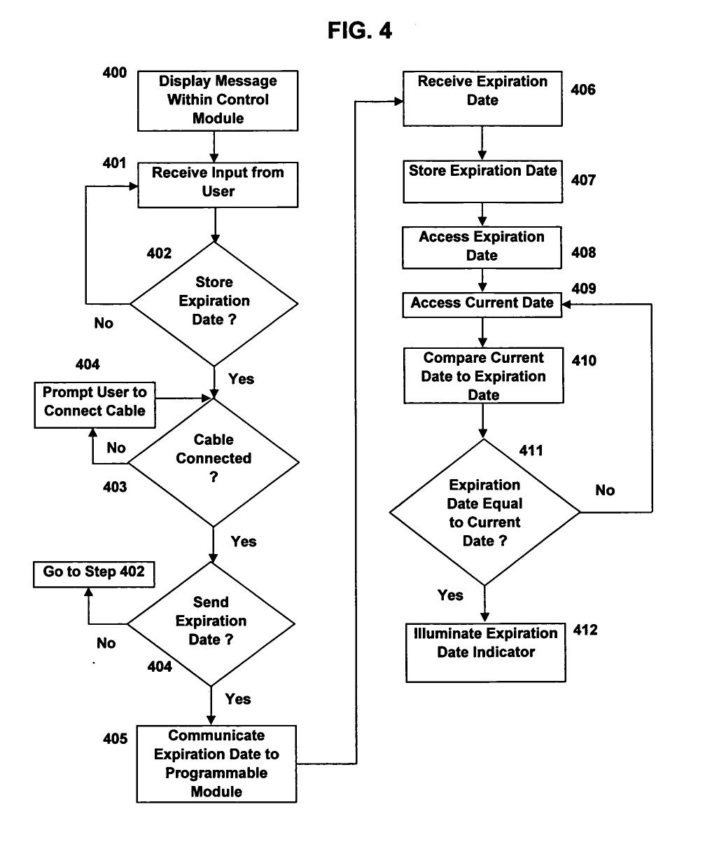

FIG. 4 illustrates a method for providing an expiration date using an expiration date verification system according to one aspect of the invention. The method may be employed by systems 100, 200, or 300 illustrated in FIGS. 1-3 or various other types of systems or devices operable to provide the method of FIG. 4.

The method begins at step 400 when a default message displayed to a user to assist a user with operating a control module. For example, a message such as ‘ENTER AN EXPIRATION DATE’ may be displayed and as a user may select an ‘enter key’ and a default format for entering a date may also be displayed. For example, a format such as ‘MM-DD-YYYY’, ‘DD-MM-YYYY’, etc. may be displayed to a user and, upon a user entering an expiration date at 401, a user may then select a store or enter button and a confirmation message such as “STORE EXPIRATION DATE” may be displayed to a user at 402. If the expiration date is not to be entered or is incorrect, as user may select a clear button and the method proceeds to step 401 and allows a user to enter or edit the date. If the expiration date is to be stored, as user may select an enter key and the new expiration date is stored within memory and an inquiry is made to determine if a communication cable is connected at 403. If a cable is not connected, a user is prompted to connect a cable at 404. In one embodiment, a wireless communication medium may be employed and as such a cable would not be needed to establish a connection. As such, the method may be modified to determine if a ‘wireless link’ has been established.

If a cable is connected, a user is prompted to “SEND EXPIRATION DATE” to the programmable expiration date module. If an expiration date is not to be communicated, the method proceeds to step 402 and a user may enter or edit a date. If an expiration date is to be communicated, the expiration date is communicated to the programmable expiration date module at step 405. Various types of protocols may be used to communicate a message including a TCP/IP protocol, mater-slave communication protocol, or any other type of protocol operable to communicate information between electronic devices.

Upon a programmable expiration date module receiving an expiration date at 406, the expiration date is stored within memory of the programmable expiration date module 407. For example, the expiration date may be stored at a specific location or address within a memory of the programmable expiration date module. However, in other embodiments, the expiration date may be stored in a different location than the previous expiration date and a reference or pointer to the current location may be provided. At step 408, the expiration date is accessed and a current date is determined at 409. A current date may be provided by a processor or digital clock maintained by programmable expiration date module. Upon accessing a current date at 409, the expiration date is compared to the current date at 410 and if the expiration date is equal to the current date at 411, an indicator associated with the programmable expiration date module is illuminated indicating that an expiration date has been determined. If at step 411, it is determined that an expiration date has not been encountered, the method proceeds to step 409 and repeats.

The method of FIG. 4 may be modified in various ways. For example, the method may be modified to illuminate an expiration date indicator at a time different than the expiration date. For example, an expiration date indicator may be illuminated one or days prior to the expiration date to indicate that an expiration date is approaching. In another form, an indicator may be operable to display more than one color and, depending on how close the expiration date is, a specific indicator, or color of indicator, may be displayed. For example, if an current date is within a week of the expiration date, a yellow indicator may be illuminated. Upon the current date being equal to an expiration date, a red indicator may be illuminated. In this manner, a programmable expiration date module may be used to monitor how close an item is to expiring. Other embodiments for providing a visual indicator based on an expiration date may also be employed.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A programmable expiration date verification system comprising:
a programmable expiration date module including:
a memory device operable to store an expiration date;
a communication port operable to receive a communication including the expiration date;
a processor operably coupled to the memory, the processor operable to determine the expiration date; and
a visual indicator operable to be altered by the processor in response to determining the expiration date; and
a control module including:
an input keypad operable to receive an entry of the expiration date;
a display operable to display the entered expiration date; and
a communication port operable to communicate the expiration date to the programmable expiration date module.

2. The system of claim 1, further comprising the programmable expiration date module operable to alter the visual indicator prior to the expiration date.

3. The system of claim 1, further comprising the programmable expiration date module operable to alter the visual indicator on the expiration date.

4. The system of claim 3, further comprising the programmable expiration date module operable to illuminate the visual indicator in response to a second expiration date.

5. The system of claim 1, further comprising the programmable expiration date module operable to extinguish the visual indicator.

6. The system of claim 1, further comprising the programmable expiration date module operable to receive and store a second expiration date.

7. The system of claim 1, wherein the programmable expiration date module operable includes a round housing no greater than one (1) inch in diameter.

8. The system of claim 7, wherein the programmable expiration date module includes a coupling mechanism operable to couple the round housing to an article.

9. The system of claim 1, wherein the display is operable to display plural colors in response to determining the expiration date.

10. A control module operable to be used in association with a programmable verification system operable to communicate a digital representation of an expiration date to a programmable expiration date module, the control module comprising:
an input keypad operable to receive an entry of the expiration date;
a display operable to display the entered expiration date; and
a communication port operable to communicate the expiration date to the programmable expiration date module.

11. The module of claim 10 further comprising a processor operable to initiate communication of the expiration date to the programmable expiration date module.

12. The module of claim 11 wherein the programmable expiration date module comprises:
illumination means for indicating when the expiration date has expired;
coupling means for coupling the programmable expiration date module to an article; and
communication means for receiving an updated expiration date via the communication port of the control module.

13. The module of claim 11 wherein the programmable expiration date module includes:
a memory device operable to store the expiration date;
a communication port operable to receive the communication including the expiration date;
a processor operably coupled to the memory, the processor operable to determine the expiration date; and
a visual indicator operable to be altered by the processor in response to determining the expiration date.

14. The module of claim 13, wherein the programmable expiration date module comprises a counter operably associated with the processor.

15. The module of claim 13, wherein the control module communication port includes a wireless enabled communication module.

16. The module of claim 13, wherein the programmable expiration date module further comprises a power supply including a replaceable battery.

17. The module of claim 17, wherein the programmable expiration date module further comprises a clip provided in association with the housing and operable to be coupled to an article.

18. A programmable expiration date module operably associated with a verification system operable to provide an expiration date for an article, the system including a control module operable to communicate the expiration date for the article, the module comprising:
a memory device operable to store the expiration date;
a communication port operable to receive the communication including the expiration date; and
an indicator operable to be altered in response to determining the expiration date.

19. The module of claim 18 wherein the control module comprises a portable handheld electronic device.

20. The module of claim 18 further comprising the communication port operable to receive the expiration date using infra-red communication.
